(19) United States
(12) Patent Application Publication
(10) Pub. No.: US 2021/0109895 A1
(43) Pub. Date: Apr. 15, 2021

(54) DETERMINING USER INTERFACE CONTEXTS FOR REQUESTED RESOURCES

(71) Applicant: Citrix Systems, Inc., Ft. Lauderdale, FL (US)

(72) Inventors: Sagar Thirumala Umashankar, Raleigh, NC (US); Robert Jakubowski, Raleigh, NC (US)

(73) Assignee: Citrix Systems, Inc., Ft. Lauderdale, FL (US)

(21) Appl. No.: 16/599,859

(22) Filed: Oct. 11, 2019

(51) Int. Cl. G06F 16/176; G06F 16/182; H04L 29/08

(52) U.S. Cl. CPC G06F 16/176; H04L 67/327; G06F 16/183

(57) ABSTRACT

A computer system for inferring a context from which a resource was selected in a distributed file sharing system is provided. The system includes a processor that is configured to receive a first connection request from a client agent and transmit a response to the first connection request to the client agent, the response including a resource collection that includes at least one resource. The processor is further configured to receive a request for the at least one resource from the client agent and generate a context inference indicating the client agent selected the at least one resource from the resource collection. The processor is further configured to receive a second connection request from the client agent, select an updated resource collection for transmission to the client agent based on the context inference, and transmit the updated resource collection to the client agent.

### BACKGROUND

Distributed file sharing systems enable users to access files for a variety of purposes at various locations. Most file sharing systems implement a user interface that allows users to upload files to a central repository, download files from the central repository, and to share those files among their own devices and/or with other users. Shared files can be reviewed, checked-out, edited, or otherwise accessed within the central repository. To access the files, a user can access a client device that provides a user interface. The user can interact with the user interface to perform one or more actions on the shared files as noted above.

### SUMMARY

In at least one example, a computer system for inferring a context from which a resource was selected in a distributed file sharing system is provided. The computer system includes a memory, a network interface, and at least one processor coupled to the memory and the network interface. The at least one processor is configured to receive, from a first client agent via the network interface, a first connection request; transmit, to the first client agent via the network interface, a response to the first connection request, the response including a resource collection including at least one resource; receive, from the first client agent via the network interface, a request for the at least one resource; generate a context inference based upon the request for the at least one resource, the context inference indicating the first client agent selected the at least one resource from the resource collection; receive, via the network interface, a second connection request from the first client agent; select, based on the context inference, an updated resource collection for transmission to the first client agent; and transmit, to the first client agent via the network interface, the updated resource collection.

Implementations of the system can include one or more of the following features. In the system, the at least one processor can be further configured to receive, via the network interface, a third connection request from a second client agent; identify an association between the first client agent and the second client agent; select, based on the association and the context inference, the resource collection for transmission to the second client agent; and transmit, to the second client agent via the network interface, the resource collection.

In the system, the at least one processor can be further configured to generate, in response to reception of the first connection request, a resource context including a session identifier, a resource identifier, a creation timestamp, and a resource collection identifier, and wherein to generate the context inference includes fetching the resource context using the session identifier, the resource identifier, and a current timestamp.

In the system, the at least one processor can be further configured to receive page hit information including a page hit timestamp from the first client agent; generate, in response to reception of the first connection request, a resource context including at least a creation timestamp; and generate the context inference based upon a comparison of the page hit timestamp and the creation timestamp.

In the system, the response to the first connection request can include metadata including a context identifier for each of a plurality of resource collections. In some examples of the system, the at least one processor can be further configured to receive the request for the at least one resource, the request for the at least one resource including a portion of the metadata; and generate the context inference based upon the at least a portion of the metadata. In some examples of the system, the at least a portion of the metadata can be appended to the request for the at least one resource by the client agent in response to a user-selection of the requested at least one resource.

In the system, the at least one processor can be further configured to generate a response to the request for the at least one resource, the response to the request for the at least one resource including at least a portion of the requested at least one resource.

In another example, a method of inferring a context from which a resource was selected in a distributed file sharing system is provided. The method includes acts of receiving, by a at least one processor, a first connection request from a first client agent via a network interface operably coupled to the at least one processor; transmitting, by the at least one processor, a response to the first connection request to the first client agent via the network interface, the response including a resource collection including at least one resource; receiving, by the at least one processor, a request for the at least one resource from the first client agent via the network interface; generating, by the at least one processor, a context inference based upon the request for the at least one resource, the context inference indicating the first client agent selected the at least one resource from the resource collection; receiving, by the at least one processor, a second connection request from the first client agent via the network interface; selecting, by the at least one processor, an updated resource collection for transmission to the first client agent based on the context inference; and transmitting, by the at least one processor, the updated resource collection to the first client agent via the network interface.

Implementations of the method of inferring a context from which a resource was selected in a distributed file sharing system can include one or more of the following features. For example, the method can further include an act of receiving, by the at least one processor, a third connection request from a second client agent via the network interface; identifying, by the at least one processor, an association between the first client agent and the second client agent; selecting, by the at least one processor, the resource collection for transmission to the second client agent based on the association and the context inference; and transmitting, by the at least one processor, the resource collection to the second client agent via the network interface.

The method can further include an act of generating, by the at least one processor, a resource context in response to reception of the first connection request, the resource context including a session identifier, a resource identifier, a creation timestamp, and a resource collection identifier and wherein to generate the context inference includes fetching the resource context using the session identifier, the resource identifier, and a current timestamp.

The method can further include the acts of receiving, by the at least one processor, page hit information including a page hit timestamp from the first client agent; generating, by the at least one processor, a resource context including at least a creation timestamp in response to reception of the first connection request; and generating, by the at least one processor, the context inference based upon a comparison of the page hit timestamp and the creation timestamp.

In the method, the response to the first connection request can include metadata including a context identifier for each of a plurality of resource collections. In some examples, the method can further include the acts of receiving, by the at least one processor, the request for the at least one resource, the request for the at least one resource including a portion of the metadata; and generating, by the at least one processor, the context inference based upon the at least a portion of the metadata.

In another example, a non-transitory computer readable medium storing computer executable instructions to infer a context from which a resource was selected in a distributed file sharing system is provided. The computer executable instructions include instructions to receive a first connection request from a first client agent via a network interface; transmit a response to the first connection request to the first client agent via the network interface, the response including a resource collection including at least one resource; receive a request for the at least one resource from the first client agent via the network interface; generate a context inference based upon the request for the at least one resource, the context inference indicating the first client agent selected the at least one resource from the resource collection; receive a second connection request from the first client agent via the network interface; select an updated resource collection for transmission to the first client agent based on the context inference; and transmit the updated resource collection to the first client agent via the network interface.

Implementations of the computer readable medium storing computer executable instructions to infer a context from which a resource was selected in a distributed file sharing system can include one or more of the following features. For example, in the computer readable medium of claim 15, the instructions can further include instructions to receive a third connection request from a second client agent via the network interface; identify an association between the first client agent and the second client agent; select the resource collection for transmission to the second client agent based on the association and the context inference; and transmit the resource collection to the second client agent via the network interface.

In the computer readable medium, the instructions can further include instructions to generate a resource context in response to reception of the first connection request, the resource context including a session identifier, a resource identifier, a creation timestamp, and a resource collection identifier and wherein to generate the context inference includes fetching the resource context using the session identifier, the resource identifier, and a current timestamp.

In the computer readable medium of claim 15, the instructions can further include instructions to receive page hit information including a page hit timestamp from the first client agent; generate a resource context including at least a creation timestamp in response to reception of the first connection request; and generate the context inference based upon a comparison of the page hit timestamp and the creation timestamp.

In the computer readable medium, the response to the first connection request can include metadata including a context identifier for each of a plurality of resource collections. In some examples of the computer readable medium, the instructions can further include instructions to receive the request for the at least one resource, the request for the at least one resource including a portion of the metadata; and generate the context inference based upon the at least a portion of the metadata.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of an enhanced file sharing system, in accordance with at least one example of the present disclosure.

FIG. 2 is a block diagram of a network environment of computing devices in which various aspects of the present disclosure can be implemented.

FIG. 3 is a block diagram of a computing device that can implement one or more of the computing devices of FIG. 2, in accordance with at least one example of the present disclosure.

FIG. 4 is a block diagram of the file sharing system of FIG. 1 as implemented by a configuration of computing devices, in accordance with at least one example of the present disclosure.

FIG. 5 is a sample user interface screen for accessing a distributed file sharing system, in accordance with at least one example of the present disclosure.

FIG. 6A is a sequence diagram of a first context inference process, in accordance with at least one example of the present disclosure.

FIG. 6B is a flow diagram that corresponds at least in part to the sequence diagram of FIG. 6A.

FIG. 7A is a sequence diagram of a second context inference process, in accordance with at least one example of the present disclosure.

FIG. 7B is a flow diagram that corresponds at least in part to the sequence diagram of FIG. 7A.

FIG. 8A is a sequence diagram of a first context inference process, in accordance with at least one example of the present disclosure.

FIG. 8B is a flow diagram that corresponds at least in part to the sequence diagram of FIG. 8A.

FIG. 9A is a sequence diagram of a process for appending client-side enhanced metadata for use with a context inference process, in accordance with at least one example of the present disclosure.

FIG. 9B is a flow diagram that corresponds at least in part to the sequence diagram of FIG. 9A.

### DETAILED DESCRIPTION

As summarized above, various examples described herein are directed to systems for inferring in what context a user has requested a resource and methods and processes for use of such a system in an enhanced file sharing system. These systems and methods overcome technical difficulties that arise in other file sharing systems where, for example, a server cannot determine from what resource context or resource collection a client has selected a particular resource. For example, due to a dearth of contextual information for selections, other file sharing systems are unable to improve the user interfaces they present by, for example, improving files that are recommended to a user based upon the user's historical information.

To improve a user's experience with a distributed file sharing system, the system may include one or more predictive processes used to generate a list of recommended files that a user may be likely to want to access during a particular session. The list of recommended files can be generated based upon historic usage patterns for the user, a list of the most recently used files for the user, files that other users with similar historical information as the user interact with on a regular basis, and other similar factors. To improve on the recommendations, the processes can be updated regularly based upon system feedback. For example, by monitoring how often a user accesses one or more of the recommended files presented to the user, the system can learn if the user regularly looks to the list of recommended files for assistance and how accurate the list is to the user's needs during any particular session.

However, without modifying the client-side software to include specific monitoring functionality, it is often difficult to determine exactly how a user is accessing a file or other resource in a distributed file sharing system. For example, if a particular file is provided to a user in both a list of recommended files as well as a list of recently used files, the server may not be able to accurately determine from which list, or resource context as referred to herein, the user actually selected the particular file. Without such information, it may be difficult for a researcher or other similar programmer to accurately evaluate the performance and value of the processes that are generating the list of recommended files.

Thus, and in accordance with at least some examples disclosed herein, enhanced file sharing systems, methods, and processes are provided that include improved inference regarding from what resource context has a user selected a particular resource. These systems, methods, and processes preserve the quality of a user's experience by minimizing the impact and changes required on client-side software to implement the improved inference techniques.

In some examples, a processor associated with a server included in, for example, a distributed file sharing system, can be configured to receive a first connection request. The processor can be configured to transmit, to the first client agent via the network interface, a response to the first connection request, the response including a resource collection including at least one resource. The processor can receive a request for the at least one resource from the first client agent and generate a context inference based upon the request for the at least one resource, the context inference indicating the first client agent selected the at least one resource from the resource collection. Based upon this context inference, the processor can improve or otherwise alter future resource collections transmitted to the first client agent. For example, the processor can receive a second connection from the first client agent. The processor can select an updated resource collection for transmission to the first client agent based on the context inference. The processor can then transmit the updated resource collection to the first client agent for user access.

As will be understood in view of this disclosure, a number of approaches to generating the context inference can be implemented as disclosed herein. For example, the processor can generate the context inference based upon analysis of resource collection timing information to determine which resource collection was delivered to a client agent most recently. In some examples, a client agent can be configured to monitor page hit information that includes information about user selections and provide this page hit information to a server. The server can analyze the page hit information to determine what resource collection the user was interacting with when a particular resource was selected. In other examples, a resource collection can include embedded enhanced metadata that is processed by, for example, server middleware of a client agent. In certain implementations, the enhanced metadata can include, for example, an indication of what resource collection a particular resource is classified or otherwise grouped into. Upon request of a resource by a client, the request is updated to include at least a portion of the enhanced metadata that is indicative of which resource collections the selected resource as included in. The processor can analyze the enhanced metadata to determine a likelihood that a user accessed a particular resource collection to select a resource and can generate the context inference accordingly.

In some examples, the generated resource context can be used to improve or enhance a user experience for another user. For example, in some examples, the processor associated with the server as described above can receive a second connection request from a second client agent. The processor can identify an association between the first client agent and the second client agent such as similar user groups, similar job titles or access levels, and other similar user characteristics. The processor can select the resource collection for transmission to the second client agent based upon the association and the context inference and transmit the resource collection to the second client agent.

Examples of the methods, systems, and processes discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Enhanced File Sharing System

In some examples, an enhanced file sharing system is configured to implement file sharing or access to remote users, thereby providing a central repository of files or other similar resources to a group of trusted users. In certain systems, a central computing device such as a server can monitor a user's interaction with the system to determine patterns for a particular user. Based upon these patterns, the server can create a customized user interface for future interactions with the user, thereby enhancing the user's overall experience with the file sharing system.

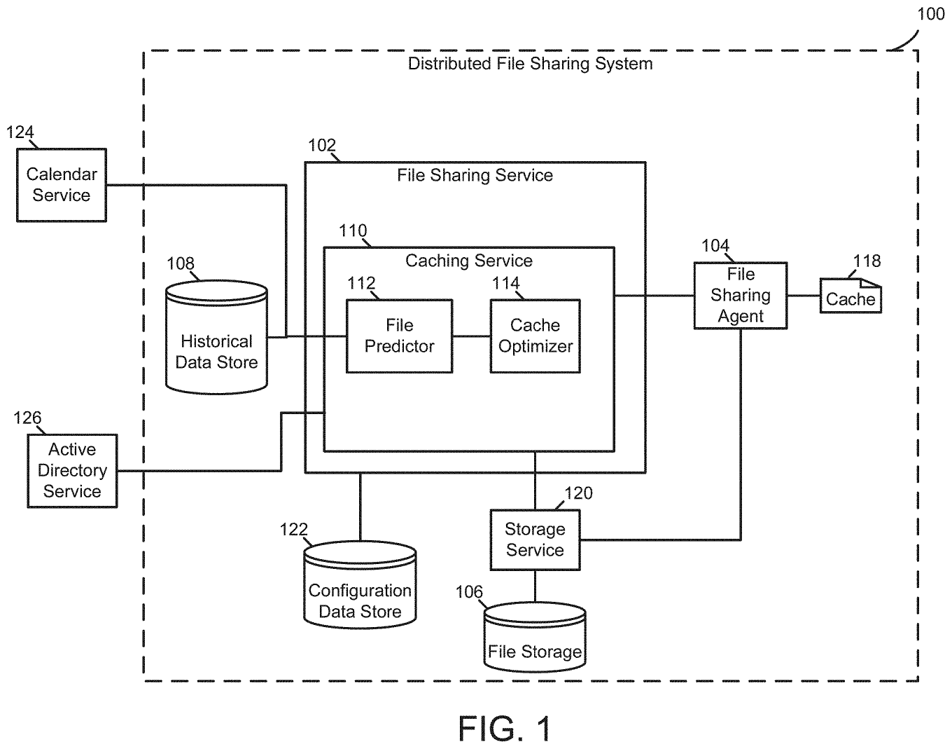

FIG. 1 illustrates a logical architecture of an enhanced file sharing system 100 in accordance with some examples. As shown, the system 100 includes a file sharing service 102, a file sharing agent 104, a file storage service 120, a centralized file storage 106, a configuration data store 122, an historical data store 108, and a local cache 118. The sharing service 102 includes a caching service 110. The caching service 110 includes a file predictor 112 and a cache optimizer 114. Also depicted in FIG. 1 are an active directory service 126 and a calendar service 124.

In some examples, the sharing service 102 is configured to implement a set of enterprise file sharing features. This set of features can include file-related features (e.g., file uploading, file storage, file downloading, file sharing, file synchronization, etc.), security features (e.g., encryption, user authentication, device authentication, etc.), and analytical features (e.g., tracking usage of the system 100, calculating and provide metrics descriptive of usage, etc.). As illustrated in FIG. 1, the sharing service 102 is configured to implement this feature set by executing a variety of processes, including processes that involve communications with the agent 104, the storage service 120, and the historical data store 108.

In some examples, the sharing service 102 is configured to communicate with the agent 104, the storage service 120, and the historical data store 108 by exchanging (i.e., transmitting and/or receiving) messages via one or more system interfaces (e.g., a web service application program interface (API), a web server interface, fibre channel interface, etc.). For instance, in some examples, one or more server processes included within the sharing service 102 exchange messages with various types of client processes via the systems interfaces. These client process can include browsers and/or more specialized programs—such as the agent 104.

In certain examples, the messages exchanged between the sharing service 102 and a client process can include requests for authorization to upload, download, share, and/or synchronize files. The messages can also include requests to authenticate users or devices and/or requests to configure features supported by the sharing service 102.

In these examples, the sharing service 102 is configured to respond to reception of an authorization request by communicating with the storage service 120 to determine, via a set of rules, whether an operation identified in the request is allowable. Further, in these examples, the sharing service 102 is configured to notify the client process (e.g., the agent 104) of the allowability of the requested operation via a response. In addition, the sharing service 102 is configured to maintain the historical data store 108 where the sharing service 102 receives a message from the storage service 120 that an authorized operation was successfully executed. The historical data store 108 is configured to store usage data consisting of records of each instance of file access involving the system 100. Records stored in the historical data store 108 can include an identifier of the file accessed, an identifier of a user accessing the file, an identifier of a client device accessing the file, a resource context through which the user accessed the file (as described in greater detail herein), and other similar historical data.

In some examples, the sharing service 102 is configured to respond to reception of an authentication request by communicating with an authentication service (e.g., the active directory service 126 of FIG. 1) to determine, via a set of rules, whether an entity (e.g., a user or device) identified in the authentication request is authorized to access the system 100. Further, in these examples, the sharing service 102 is configured to notify, via a response message, the client process as to whether the entity is authorized to access the system 100.

In some examples, the sharing service 102 is configured to respond to reception of a request to change its configuration by determining, via a set of rules, whether the change is allowable. Further, in these examples, the sharing service 102 is configured to execute the change where the change is allowable and notify the client process of the allowability and result of the requested change via a response. In at least one example, the sharing service 102 is configured to execute configuration changes by storing configuration data in the configuration data store 122. This configuration data can, for example, associate features (e.g., an automatic synchronization feature) with users, files, and file directories.

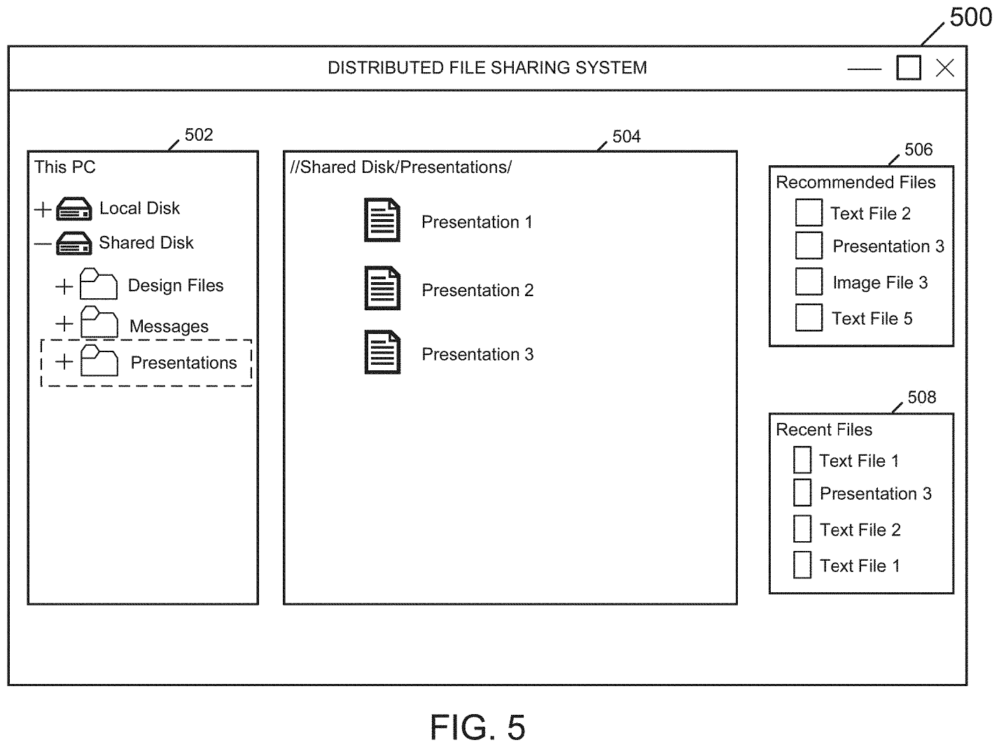

In some examples, the storage service 120 is configured to manage the file storage 106. The file storage 106 is configured to store files serviced by the system 100. In some examples, the storage service 120 is configured to implement and expose a system interface (API) through which the other components of the system 100 access the file storage 106 and data descriptive of the files stored therein. For example, where the storage service 120 receives a request to execute an authorized, file-related operation, the storage service 120 responds to reception of the request by processing the request and notifying the requestor and the file sharing service 102 of the operations results. Further, in some examples, the storage service 120 is configured to load balance requests and responses received via the system interface. More details regarding processes executed by the storage service 120, in some examples, are articulated below with reference to FIG. 5.

In some examples, the agent 104 is a specialized client program configured to execute on a client device. The agent 104 manages the local cache 118. As shown in FIG. 1, the agent 104 is configured to interoperate with the sharing service 102 to implement the file-related and security features described above. In these examples, the agent 104 exchanges messages with the sharing service 102 via the system interfaces described above. The messages can include requests for authorization, authentication, and/or configuration as described above. Such messages can be generated, for example, by interaction between a user and a user interface provided by the agent 104.

In some examples, the agent 104 is configured to receive and process responses to authorization requests. These responses can, for example, authorize the agent 104 to execute a file-related operation, such as an upload, download, share, and/or synchronization. In response to receiving and processing an authorization response, the agent 104 can exchange messages with the storage service 120 to execute the authorized file-related operation. For instance, where the agent 104 receives a response authorizing download of a file, the agent 104 can exchange messages with the storage service 120 to request and receive the file as stored in the file storage 106. Conversely, where the agent 104 receives a response authorizing upload of a file, the agent 104 can exchange messages with the storage service 120 to transmit the file to the file storage 106.

In at least one example, where the sharing service 102 supports an automatic synchronization feature, the agent 104 exchanges messages with the sharing service 102 to configure the sharing service 102 to automatically synchronize a targeted file shared with a particular user. When executing the automatic synchronization feature, the sharing service 102, the agent 104, and the file storage 106 interoperate with one another to automatically maintain, within the cache 118, copies of any files targeted for automatic synchronization. In some examples, the sharing service 102 utilizes the caching service 110 to implement predictive caching within the cache 118.

As shown in FIG. 1, caching service 110 includes the file predictor 112 and the cache optimizer 114. In some examples, these components interoperate to identify a set of recommended files that have a high likelihood of being accessed by the identified user. In these examples, the caching service 110 is configured to receive historic file access information for the user from the file sharing service 102. For example, the historic file access information can include a list of the files that have been accessed most often by the user, a list of the files that have been accessed most recently by the user, and other similar lists of files. Based upon the historic file access information, the caching service 110 can orchestrate operation of the file predictor 112 and the cache optimizer 114 to determine the set of recommended files to be sent to the user.

In certain implementations, the file predictor 112 can be configured to execute one or more prediction processes based upon, for example, the historic file access information. The specifics of the prediction process executed by the file predictor 112 may vary between examples. Furthermore, any suitable prediction and/or forecasting technique can be executed by the file predictor 112 without departing from the scope of this disclosure.

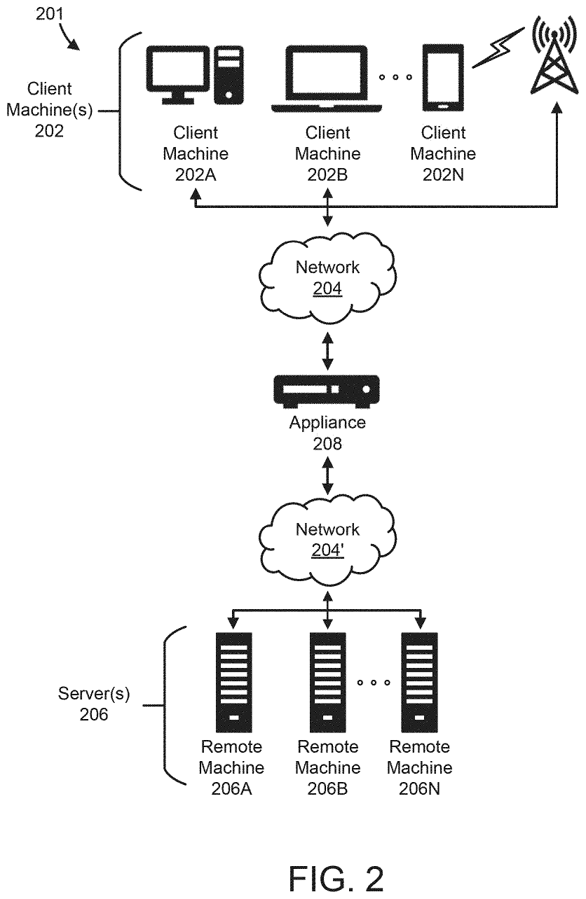

Referring to FIG. 2, a non-limiting network environment 201 in which various aspects of the disclosure can be implemented includes one or more client machines 202A-202N, one or more remote machines 206A-206N, one or more networks 204, 204′, and one or more appliances 208 installed within the computing environment 201. The client machines 202A-202N communicate with the remote machines 206A-206N via the networks 204, 204′. The computing environment 201 can also be referred to as a distributed computer system.

In some examples, the client machines 202A-202N communicate with the remote machines 206A-206N via an intermediary appliance 208. The illustrated appliance 208 is positioned between the networks 204, 204′ and may also be referred to as a network interface or gateway. In some examples, the appliance 208 can operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some examples, multiple appliances 208 can be used, and the appliance(s) 208 can be deployed as part of the network 204 and/or 204′.

The client machines 202A-202N may be generally referred to as client machines 202, local machines 202, clients 202, client nodes 202, client computers 202, client devices 202, computing devices 202, endpoints 202, or endpoint nodes 202. The remote machines 206A-206N may be generally referred to as servers 206 or a server farm 206. In some examples, a client device 202 can have the capacity to function as both a client node seeking access to resources provided by a server 206 and as a server 206 providing access to hosted resources for other client devices 202A-202N. The networks 204, 204′ may be generally referred to as a network 204. The networks 204 can be configured in any combination of wired and wireless networks.

A server 206 can be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 206 can execute, operate, or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft Internet Protocol telephone; an application for streaming video and/or audio; an application for facilitating real-time-data communications; a HyperText Transfer Protocol client; a File Transfer Protocol client; an Oscar client; a Telnet client; or any other set of executable instructions.

In some examples, a server 206 can execute a remote presentation services program or other program that uses a thin client or a remote-display protocol to capture display output generated by an application executing on a server 206 and transmit the application display output to a client device 202.

In yet other examples, a server 206 can execute a virtual machine providing, to a user of a client device 202, access to a computing environment. The client device 202 can be a virtual machine. The virtual machine can be managed by, for example, a hypervisor, a virtual machine manager (VMM), or any other hardware virtualization technique within the server 206.

In some examples, the network 204 can be: a local area network (LAN); a metropolitan area network (MAN); a wide area network (WAN); a primary public network 204; and a primary private network 204. Additional examples can include a network 204 of mobile telephone networks that use various protocols to communicate among mobile devices. For short range communications within a wireless local-area network (WLAN), the protocols can include 802.11, Bluetooth, and Near Field Communication (NFC).

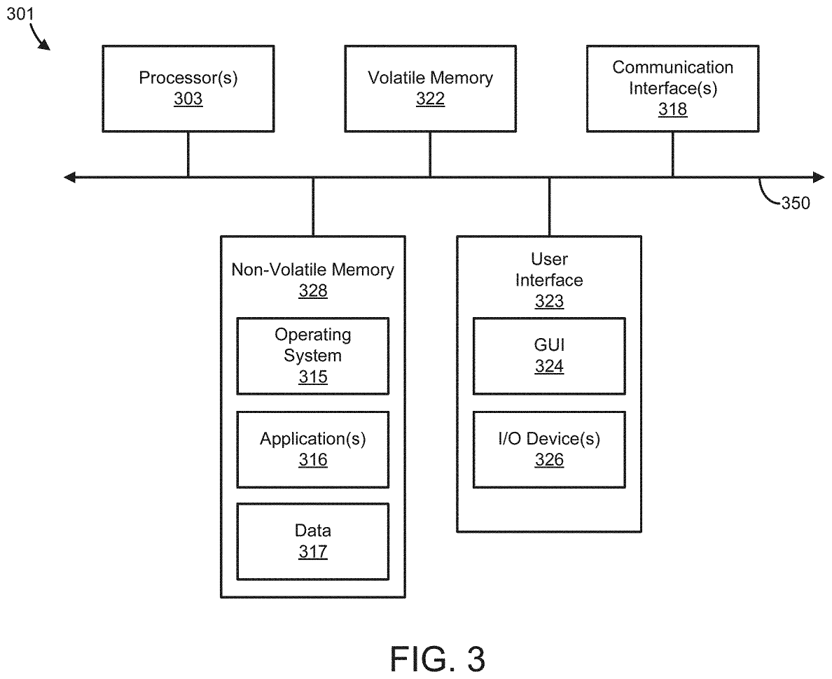

FIG. 3 depicts a block diagram of a computing device 301 useful for practicing an example of client devices 202, appliances 208 and/or servers 206. The computing device 301 includes one or more processors 303, volatile memory 322 (e.g., random access memory (RAM)), non-volatile memory 328, user interface (UI) 323, one or more communications interfaces 318, and a communications bus 350. One or more of the computing devices 301 may also be referred to as a computer system.

The non-volatile memory 328 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 323 can include a graphical user interface (GUI) 324 (e.g., a touchscreen, a display, etc.) and one or more input/output (I/O) devices 326 (e.g., a mouse, a keyboard, a microphone, one or more speakers, one or more cameras, one or more biometric scanners, one or more environmental sensors, and one or more accelerometers, etc.).

The non-volatile memory 328 stores an operating system 315, one or more applications 316, and data 317 such that, for example, computer instructions of the operating system 315 and/or the applications 316 are executed by processor(s) 303 out of the volatile memory 322. In some examples, the volatile memory 322 can include one or more types of RAM and/or a cache memory that can offer a faster response time than a main memory. Data can be entered using an input device of the GUI 324 or received from the I/O device(s) 326. Various elements of the computing device 301 can communicate via the communications bus 350.

The illustrated computing device 301 is shown merely as an example client device or server and can be implemented by any computing or processing environment with any type of machine or set of machines that can have suitable hardware and/or software capable of operating as described herein.

The processor(s) 303 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 303 can be analog, digital or mixed. In some examples, the processor 303 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The communications interfaces 318 can include one or more interfaces to enable the computing device 301 to access a computer network such as a Local Area Network (LAN), a Wide Area Network (WAN), a Personal Area Network (PAN), or the Internet through a variety of wired and/or wireless connections, including cellular connections.

In described examples, the computing device 301 can execute an application on behalf of a user of a client device. For example, the computing device 301 can execute one or more virtual machines managed by a hypervisor. Each virtual machine can provide an execution session within which applications execute on behalf of a user or a client device, such as a hosted desktop session. The computing device 301 can also execute a terminal services session to provide a hosted desktop environment. The computing device 301 can provide access to a remote computing environment including one or more applications, one or more desktop applications, and one or more desktop sessions in which one or more applications can execute.

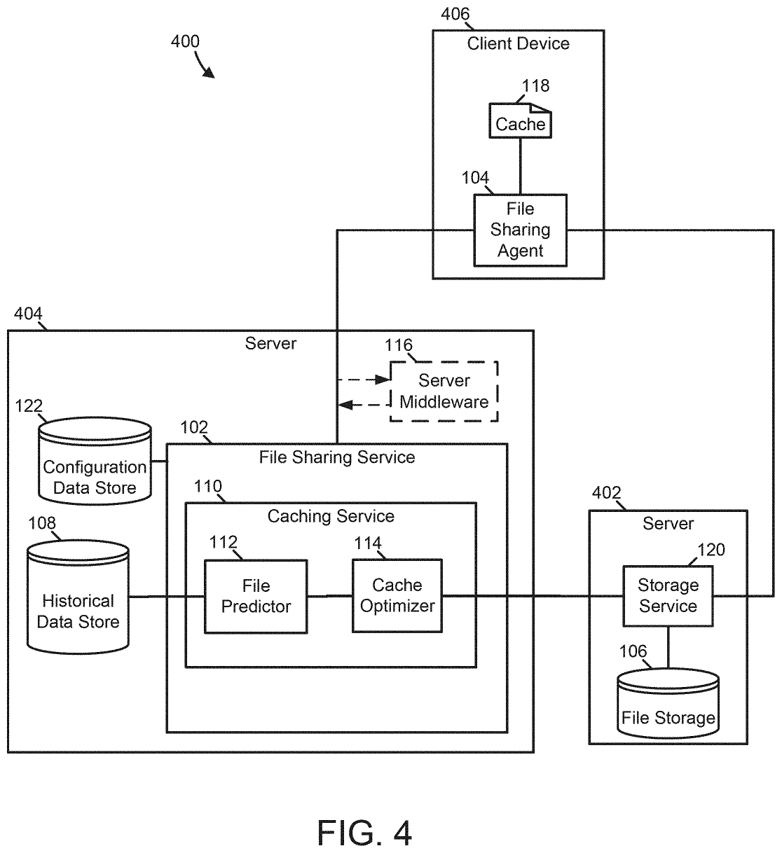

FIG. 4 illustrates an enhanced file sharing system (e.g., the system 100 of FIG. 1) configured for operation within a distributed computing platform (e.g. the network environment 201 of FIG. 2). As shown in FIG. 4, the configuration 400 includes a server computer 402, a server computer 404, and a client device 406. Within the configuration 400, the computing devices 402, 404, and 406 are communicatively coupled to one another and exchange data via a network (e.g., the networks 204 and 204′ of FIG. 2).

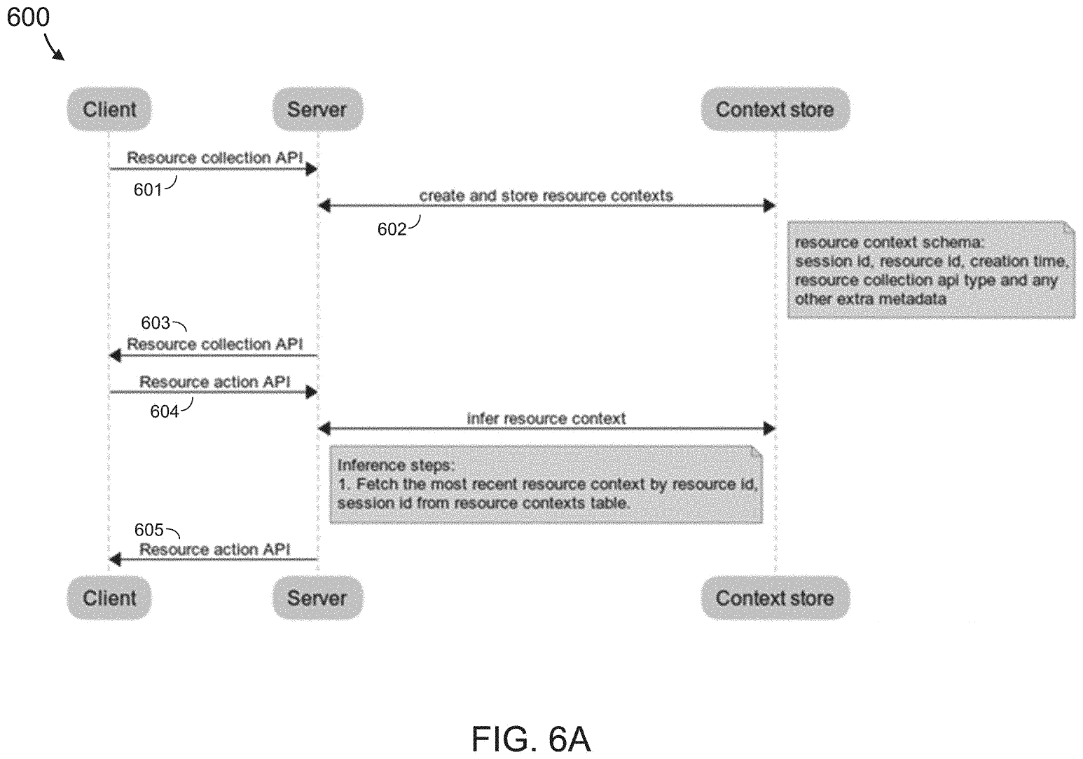

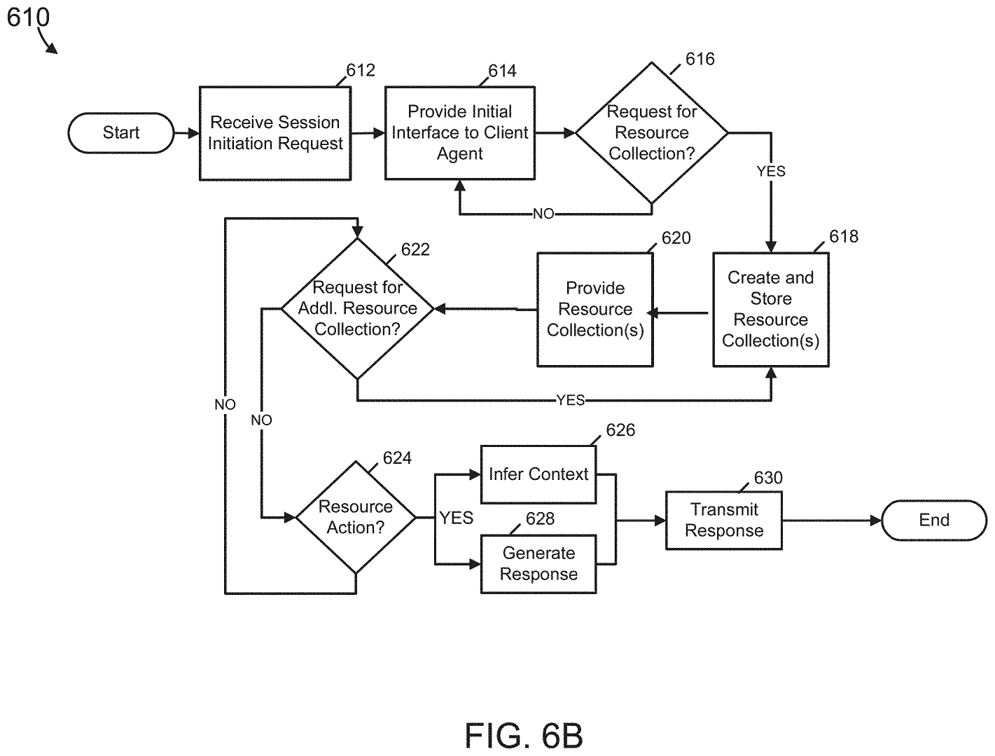

As shown in FIG. 4, the server 402 hosts the storage service 120 and the file storage 106. Some examples of processes performed by or involving server 402, and access to the files stored thereon in file storage 106, are described further below in reference to FIGS. 6A-9B. The server 404 hosts the sharing service 102 and the historical data store 108. Some examples of processes performed by or involving server 404, including determining or generating resource context inferences as described herein, are described further below in reference to FIGS. 6A-9B. The client device 406 hosts the agent 104 which maintains the cache 118. Some examples of processes performed by or involving server agent 104, and its interaction with the server 404, are described further below in reference to FIGS. 6A-9B. Many of the components illustrated in FIG. 4 are described above with reference to FIG. 1. For purposes of brevity, those descriptions will not be repeated here, but each of the components of FIG. 1 included in FIG. 4 are structured and function in FIG. 4 as described in FIG. 1.

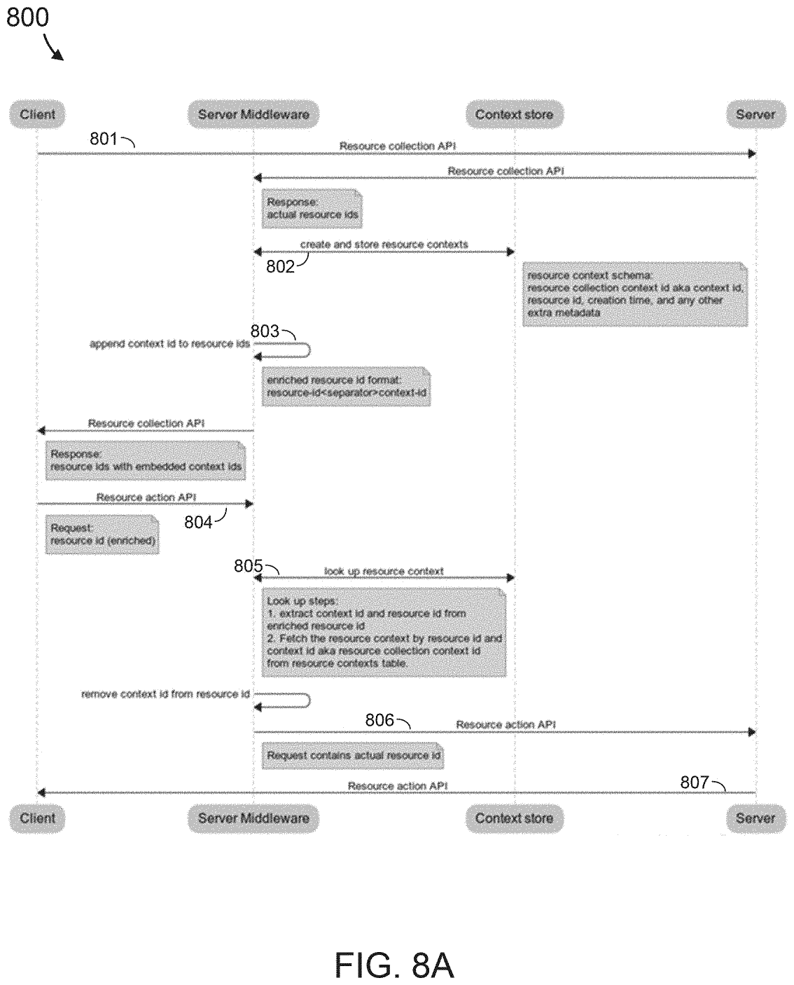

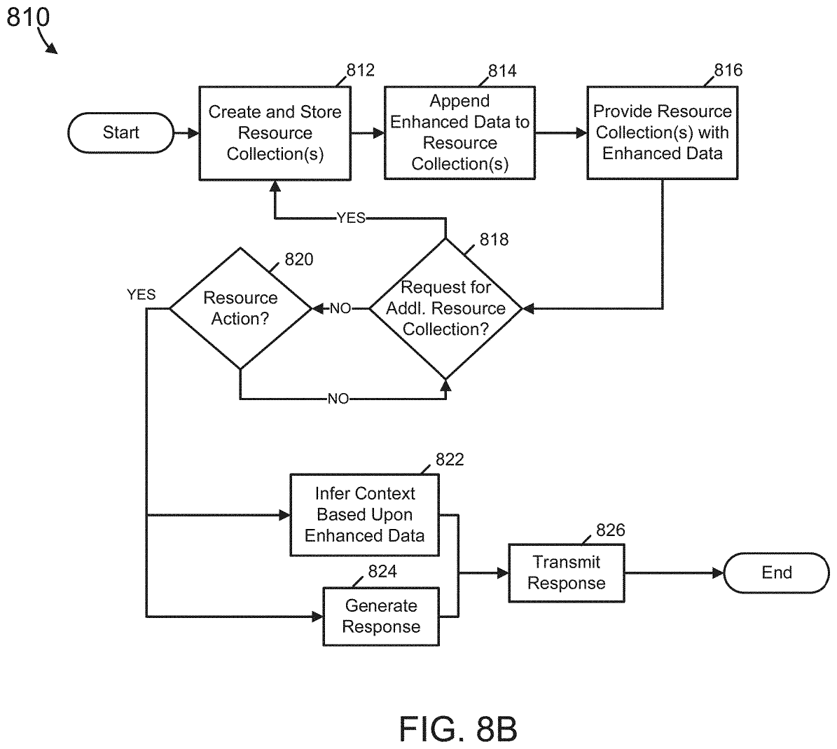

Additionally, as shown in FIG. 4, the server 404 can include server middleware 116. The server middleware 116 can be a software module or application that provides additional services to the, for example, the server 404 and/or one or both of the client 406 and the server 402. For example, as shown in FIG. 4, the server middleware 116 can be configured to monitor the input/output between server 404 and the client 406. In certain implementations, the server middleware 116 can be configured to intercept all data transferred between the server 404 and the client 406. In such an example, the server middleware 116 can be configured to perform one or more specific actions on the data being transferred between the server 404 and the client 406 as described herein below in additional detail. Some examples of processes performed by or involving server middleware 116, and such as generation of enhanced metadata as taught herein, are described further below in reference to FIGS. 8A-8B.

The configuration 400 is but one example of many potential configurations that can be used to implement the system 100. For example, in some examples, the server 404 hosts the file sharing service 102, the historical data store 108, the storage service 120, the configuration data store 122 and the file storage 106. However, in other examples, a server distinct from the servers 402 and 404 hosts the historical data store 108 and yet another distinct server hosts the file predictor 112. As such, the examples disclosed herein are not limited to the configuration 400 and other configurations are considered to fall within the scope of this disclosure.

### Accessed File Context Determination

As noted above, to improve what files are recommended to a user for quick access in a distributed file system, a computer system can execute a recommendation process to generate a list of recommended files based upon, for example, the user's recent activity. To improve the recommendation process used to generate the list of recommended files, it can be beneficial to track in what context a user selects a file for access.

FIG. 5 illustrates a sample view of a user interface screen 500 that is displayed on a client such as, for example, the client 406 and managed by a client agent such as, for example, the agent 104 as shown above. The screen 500 can be accessed and utilized by a user accessing a distributed file sharing system such as those described herein. For example, the screen 500 can be used navigate to and access one or more resources in the system.

As illustrated in FIG. 5, the screen 500 includes user interface controls 502, 504, 506, and 508. In some examples, the control 502 provides access to an initial context for accessing one or more resources. For example, as shown in FIG. 5, control 502 can include a file navigation or explorer system that provides the user with a tool for navigating a file storage structure. In certain implementations, the file storage structure can be illustrated as a hierarchal arrangement as shown in FIG. 5, with a first level showing available disks (e.g., local disk and shared disk as shown in FIG. 5) and a second level showing folders or other divisional structures within the individual disks. As shown in FIG. 5, the shared disk is expanded, showing folders design files, messages, and presentations.

The control 504 can be a navigation resource window that works in concert with user interface control 502. For example, as shown in FIG. 5, the user has selected the folder //shared disk/presentations/in user interface control 502. The control 504 can update accordingly to show resources such as files or additional folders that are stored in the selected folder from the control 502. In this example, three files presentation 1, presentation 2, and presentation 3 are stored in the selected folder and displayed in control 504. The user can then select one of the files as shown in the control 504 for access.

As further shown in FIG. 5, the screen 500 can also include the control 506, which is configured to show a list of recommended files. The list of recommended files can be generated by, for example, a process that analyzes the user's past interaction with the distributed file sharing system to determine one or more files that the user is likely to access. The process can also analyze other user's interactions with the distributed file sharing system to determine links between particular files. For example, if a high percentage of users that access file 1 also access file 2, a user that regularly accesses file 1 may also have file 2 included on a list of recommended files. It should be noted that four files are shown by way of example only in FIG. 5, and the number of recommended files as shown in control 506 can vary based upon, for example, available space in the screen 500, user preference, system configuration, and other similar settings.

The user interface screen 500, as shown in FIG. 5, also includes the control 508, which is configured to show a list of the most recently accessed files for a user. This list can include, for example, a number of the most recently accessed files for a particular user. Similar to control 506, it should be noted that four files are shown by way of example only in control 508.

As noted above, it can be valuable to determine through what context a user has accessed a particular file. For example, to improve the process that generates the list of recommended files, it can be important to know how often a user accesses a file included in the list of recommended files. This information can be used to better target the files included in the list of recommended files to be more directly in line with the types of files regularly accessed by a user. However, to determine in what context the user has accessed a file, it is important to infer what user interface control the user interacted with to access the file. For example, as shown in FIG. 5, there are three separate user interface controls that correspond to unique contexts for accessing a resource such as a file. The control 504 represents a file navigation context, the control 506 represents the recommended files context, and the control 508 represents the recent files context. In the example illustrated in FIG. 5, the file “presentation 3” is included in each context. Thus, absent any other consideration, if a user selects the file “presentation 3,” there is approximately a 33% chance that the user selected the file from any one of the three available contexts.

FIG. 6A illustrates a sample sequence diagram 600 related to process 610 as shown in FIG. 6B and described in greater detail below. The sequence diagram 600 illustrates a sample set of interactions between a client (e.g., client 406 of FIG. 4), a server (e.g., server 404 of FIG. 4), and a context store (e.g., server 402 of FIG. 4, including file storage 106). As shown in the sequence diagram 600, the client, or a client agent running on the client, can request 601 one or more resource collections using, for example, a resource collection application programming interface (API). The server can receive the request and create 602 one or more resource collections having associated resource contexts from the context store. The resource contexts can include, for example, a session identifier, a resource identifier, a creation time, a resource collection API type, and other similar metadata. The server can provide 603 the resource collections and associated resources to the client via the resource collection API.

Once the client has received the resource collections, the client can request 604 a resource action using, for example, a resource action API. The server can receive the request and access the context store to retrieve the requested resource. The server can perform the requested action and respond 605 to the client using the resource action API. In addition, the server can infer 606 the resource context based upon the requested resource action. For example, the server can infer 606 that the resource context used by the client is the resource context with the most recently issued resource identifier and session identifier from a resource contexts table stored, for example, at the context store. In a similar example, the server can infer 606 the resource context with the most recent creation time was used by the client to access the requested resource.

FIG. 6B illustrates a flow process 610 for inferring a context in which a user has requested a file or other similar resource. Process 610, as described herein, can follow a similar timing sequence as sequence 600 shown in FIG. 6A and described above. As shown in process 610, a file sharing device such as the server 404 of FIG. 4 as described above can receive 612 a session initiation request. In certain implementations, the session initiation request can include a user's access credentials such as a username and password. Based upon this information, the server can, for example, determine a level of access to grant the user and provide 614 an initial interface to the client agent. For example, the client agent can include the agent 104 of FIG. 1 as described above. The initial interface can include, for example, an interface similar to the screen 500 of FIG. 5 as described above.

The server can then determine 616 whether the client agent has requested a resource collection. For example, a resource collection can include a list of recently accessed files, a list of recommended files, a folder or drive hierarchy listing or structure, a listing of the content of a particular folder or drive, and other similar resource collection. In certain implementations, for example, the client agent can request a standard set of resource collections upon initialization of the distributed file sharing system. For example, the client agent can initially request a list of recently accessed files, a list of recommended files, and an initial hierarchal listing of the root directories that the user may access. If the server does not determine 616 that the client agent has sent a request for resource collections, the server can continue to provide the initial interface. Conversely, if the server does determine 616 that the client agent has requested a resource collection, the server can create 618 and store the resource collection. For example, the server can generate a listing of recently accessed files and/or a list of recommended files. This listing can be included in and transmitted to the client via, for example, the resource API as described above. The client agent can receive the data for the resource collection, format the information for display to the user and include on a portion of a user interface screen such as screen 500 of FIG. 5. The server can also store a copy of the listing in a historical data structure for associated with the user for future reference and analysis.

The server can provide 620 the resource collection(s) to the client agent by, for example, updating the user interface as provided to the client agent to include the resource collections. The server can then monitor communications with the client agent to determine 622 if there are any additional requests for any resource collections. For example, the user can navigate to a specific folder in the previous-provided drive hierarchal listing and the client agent can transmit a request for the contents of that folder to the server. If the server determines 622 that an additional request has been received, the server can create 618 and store the updated resource collection and provide 620 the resource collection to the client agent.

If the server determines 622 that there are no additional requests for additional resource collections, the server can determine 624 whether the client agent has requested any specific resource action. As described herein, a resource action can include a specific action that is to be performed on an identified resource such as a file. The actions can include, but are not limited to, opening the resource, copying the resource, moving the resource, deleting the resource, sharing the resource, and other similar actions. If the server determines 624 that there is no request for a specific resource action, the server can continue to determine 622 if there are any additional requests for resource collections. Conversely, if the server does determine 624 that there is a request for a resource action, the server can infer 626 what context the resource was selected from as well as generate 628 a response to the client agent. The server can then transmit 630 the response to the client agent.

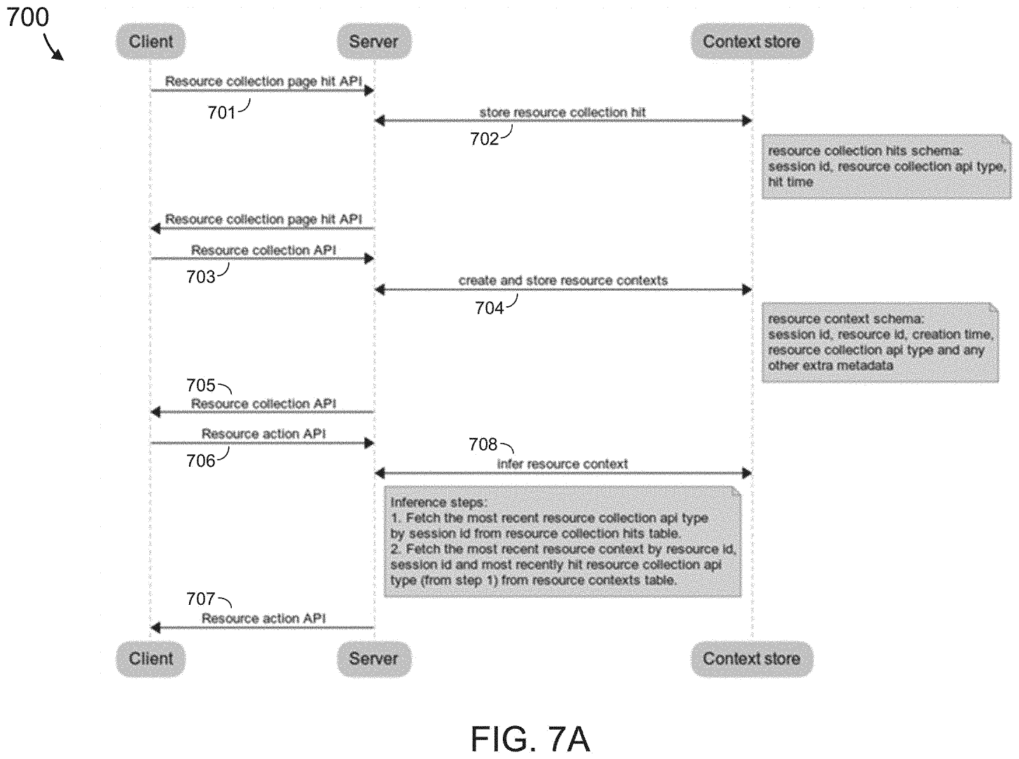

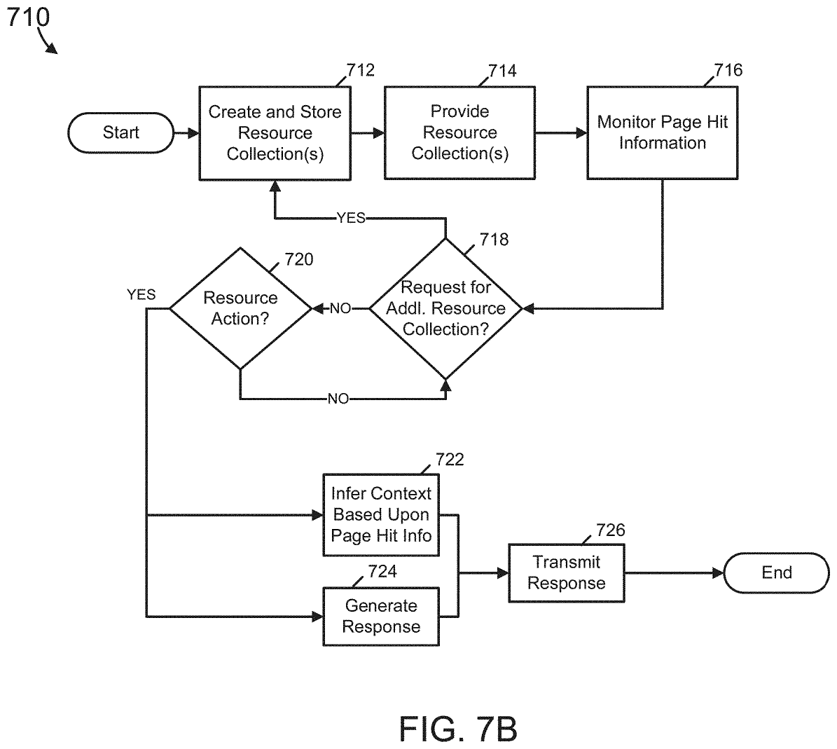

As shown in FIG. 6B, inferring 626 the context of the resource can include various processes for determining how the user selected the resource. Various examples of approaches as described in greater detail in the descriptions of FIGS. 7A-9B below. However, one process for determining the context is to determine which collections included the requested resource. If the requested resource was only included in a single resource collection available to the user, the server can infer with 100% confidence how the user selected the resource. However, if the requested resource was included in multiple resource collections that were available to the user, the server can use one or more rules to determine the most likely context from which the user selected the resource. For example, if the user requested a specific file folder structure for display that included the requested resource, the server can infer that the resource context associated with the file folder structure was most likely the resource context from which the user selected the resource, even if the resource was included in another resource collection such as a list of recently accessed files. In another example, the server can infer that the user selected a requested resource from whichever resource collection was presented to the user last in time. As noted, additional examples of inferring a resource context are provided in the following descriptions of FIGS. 7A-9B.

The process 610 as shown in FIG. 6B and described above does not require any changes to the client agent. Rather, as described above, all generation of metadata and context inference is performed by the server. However, in certain examples, the client side can be modified as well to improve the inference performance of the server. FIGS. 7A and 7B illustrates a sequence diagram 700 and a sample process 710 that implement a page hit identifier on the client agent for improved inference by the server.

FIG. 7A illustrates a sample sequence diagram 700 related to process 710 as shown in FIG. 7B and described below in greater detail. The sequence diagram 700 illustrates a sample set of interactions between a client (e.g., client 406), a server (e.g., server 404), and a context store (e.g., server 402 including file storage 106). As shown in the sequence diagram 700, the client, or a client agent running on the client, can provide 701 page hit information to the server using, for example, a page hit API. The page hit API can be a flow of information between, for example, the client agent and the server, the information can include specific information related to one or more actions of a user. In certain implementations, the page hit API can include information descriptive of the user's interaction with the user interface such as screen 500 of FIG. 5. The page hit information can include a user-specific message for a particular session and include information specific to that session such as selection type and timing information. For example, the page hit information can include a session identifier, a resource collection selected type, and a page hit time. The server can record 702 the page hit information in, for example, a page hit table stored in the context store.

The client can also transmit 703 a request for one or more resource collections using, for example, a resource collection API as described above. The server can receive the request and create 704 one or more resource collections having associated resource contexts from the context store. The resource contexts can include, for example, a session identifier, a resource identifier, a creation time, a resource collection type, and other similar metadata. The server can provide 705 the resource collections and associated resources to the client via the resource collection API.

Once the client has received the resource collections, the client can request 706 a resource action using, for example, a resource action API. The server can receive the request and access the context store to retrieve the requested resource. The server can perform 707 the requested action and respond to the client using the resource action API. In addition, the server can infer 708 the resource context based upon the requested resource action and the page hit information. For example, the server can fetch the most recent resource collection type and session identifier information from the page hit table as stored in the context store. The server can then correspond this information with information related to the requested resource from the client to determine what page hit information most likely corresponds to the resource context used by the client to select the requested resource.

Referring now to FIG. 7B, a file sharing device such as server 404 of FIG. 4 as described above can receive a session initiation request and provide the initial interface to the client agent as described above in FIG. 6B and included in process 610. As shown in FIG. 7B, process 710 can include the server creating 712 and storing a requested resource collection. For example, the server can generate a listing of recently accessed files and/or a list of recommended files. The server can provide 714 the resource collection(s) to the client agent by, for example, updating the flow of information as provided to the client agent such that the client agent can update the user interface to include the resource collections. Additionally, the server can monitor 716 for page hit information from the client agent. For example, the server can monitor the page hit API as described above for page hit information.

For example, the client agent can be configured to update a page hit API to provide information to the server based upon which portion of a user interface screen the user is interacting with. The page hit information can include, for example, a session identifier, a resource collection type selected, a time of the section.

As further shown in FIG. 7B, the server can monitor communications with the client agent to determine 718 if there are any additional requests for any resource collections. For example, the user can navigate to a specific folder in the previous-provided drive hierarchal listing and the client agent can transmit a request for the contents of that folder to the server. If the server determines 718 that an additional request has been received, the server can create 712 and store the updated resource collection and provide 714 the resource collection to the client agent while continuing to monitor 716 the page hit information.

If the server determines 718 that there are no additional requests for additional resource collections, the server can determine 720 whether the client agent has requested any specific resource action. As described herein, a resource action can include a specific action that is to be performed on an identified resource such as a file. The actions can include, but are not limited to, opening the resource, copying the resource, moving the resource, deleting the resource, sharing the resource, and other similar actions. If the server determines 720 that there is no request for a specific resource action, the server can continue to determine 718 if there are any additional requests for resource collections. Conversely, if the server does determine 720 that there is a request for a resource action, the server can infer 722 what context the resource was selected from based upon the page hit information as well as generate 724 a response to the client agent. The server can then transmit 726 the response to the client agent.

As further shown in FIG. 7B, in this example, inferring 722 the context of the resource can include matching the most recent page hit times as received from the client agent with a time of the request for a resource action. By matching corresponding or close times, the server can increase the likelihood that the inference of from what context the user selected the resource can be improved.

The processes 610 and 710 as shown in FIGS. 6B and 7B and described above use standard resource collection requests and responses. As described above, all generation of metadata and context inference is performed by the server according to traditional distributed file system functions. However, in certain examples, a server agent such as a server middleware can be included as a software application or module on the server, such as server middleware 116 of FIG. 4. In certain implementations, the server middleware can be configured to intercept and process communications between the server and the client. It should be noted that the server middleware as described herein in the discussion of FIGS. 8A and 8B is a software module implemented on the server by way of example only. In actual implementation, the server middleware can be implemented on another device such as a router or gateway that is positioned between the server and the client.

FIG. 8A illustrates a sample sequence diagram 800 related to process 810 as shown in FIG. 8B and described below in additional detail. The sequence diagram 800 illustrates a sample set of interactions between a client (e.g., client 406 of FIG. 4), a server (e.g., server 404 of FIG. 4), server middleware (e.g., server middleware 116 of FIG. 4), and a context store (e.g., server 402 of FIG. 4, including file storage 106). As shown in the sequence diagram 800, the client, or a client agent running on the client, can transmit 801 a request for one or more resource collections using, for example, a resource collection API as described above. The server can receive the request and create 802 one or more resource collections having associated resource contexts from the context store. The resource contexts can include, for example, a session identifier, a resource identifier, a creation time, a resource collection API type, and other similar metadata. The server can provide the resource collections and associated resources to the client via the resource collection API. However, when transmitting the response to the client, the server middleware can intercept the response for further processing. As shown in sequence diagram 800, the server middleware can append 803 a context identifier to the resource identifiers in the resource collection and forward the resource collection information to the client, including the enhanced metadata.

Once the client has received the resource collection information, the client can request 804 a resource action using, for example, a resource action API. This request can include a resource identifier for the requested resource, the resource identified including the enhanced metadata including the context identifier. The server middleware can extract 805 the context identifier and resource identifier from the enhanced metadata and forward the resource identifier to the server for further processing. The server middleware can also record the extracted context identifier to, for example, the context store as an indication of the resource context utilized by the client to request the resource action.

The server can receive 806 the requested resource identifier from the server middleware and access the context store to retrieve the requested resource. The server can perform the requested action and respond 807 to the client using the resource action API. By including server middleware as described herein, the overall functionality of the server in the distributed file system can remain unchanged. Rather, the extended functionality of including and monitoring for enhanced metadata is implemented by the server middleware.

Referring now to FIG. 8B, a file sharing device such as server 404 of FIG. 4 as described above can receive a session initiation request and provide the initial interface to the client agent as described above in FIG. 6B and included in process 600. As shown in FIG. 8B, process 810 can include the server creating 812 and storing a requested resource collection. For example, the server can generate a listing of recently accessed files and/or a list of recommended files. Once created, the server, or server middleware as described herein, can append 814 enhanced metadata to the resource collection. For example, the enhanced metadata can include an embedded context identifier that corresponds directly to a particular resource collection being provided to the client that is appended to an expected piece of metadata associated with the requested resource collection. For example, as described above, each requested resource collection can include a resource identifier. In this example, the server can append 814 the resource identifier to include an additional context identifier. When processing, the client will interpret the enhanced metadata as simply the resource identifier and, as such, no additional programming or changes may be required on the client side to implement process 810 as shown in FIG. 8B.

As shown in FIG. 8B, the server can provide 816 the resource collection(s) to the client agent by, for example, updating the user interface as provided to the client agent to include the resource collections. As further shown in FIG. 8B, the server can monitor communications with the client agent to determine 818 if there are any additional requests for any resource collections. For example, the user can navigate to a specific folder in the previous-provided drive hierarchal listing and the client agent can transmit a request for the contents of that folder to the server. If the server determines 818 that an additional request has been received, the server can create 812 and store the updated resource collection, append 814 enhanced metadata to the updated resource collection, and provide 816 the resource collection to the client agent.

If the server determines 818 that there are no additional requests for additional resource collections, the server can determine 820 whether the client agent has requested any specific resource action. As described herein, a resource action can include a specific action that is to be performed on an identified resource such as a file. The actions can include, but are not limited to, opening the resource, copying the resource, moving the resource, deleting the resource, sharing the resource, and other similar actions. If the server determines 820 that there is no request for a specific resource action, the server can continue to determine 818 if there are any additional requests for resource collections. Conversely, if the server does determine 820 that there is a request for a resource action, the server can infer 822 what context the resource was selected from based upon the enhanced metadata of the resource action request as well as generate 824 a response to the client agent. The server can then transmit 826 the response to the client agent.

As further shown in FIG. 8B, in this example, inferring 822 the context of the resource can include analyzing the requested resource collection to determine what enhanced metadata is included int the request. For example, when formatting the request, the client agent can include the resource identifier along with the appended context identifier. Based upon the context identifier, the server can determine what resource context the user accessed to request the resource action.

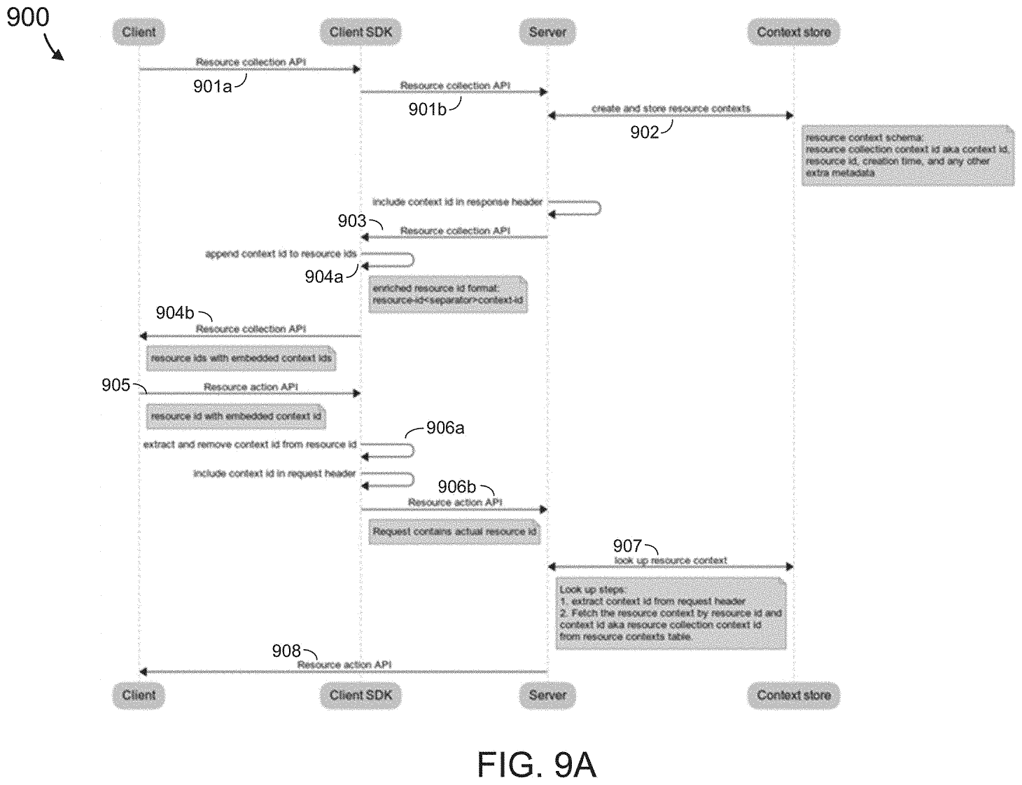

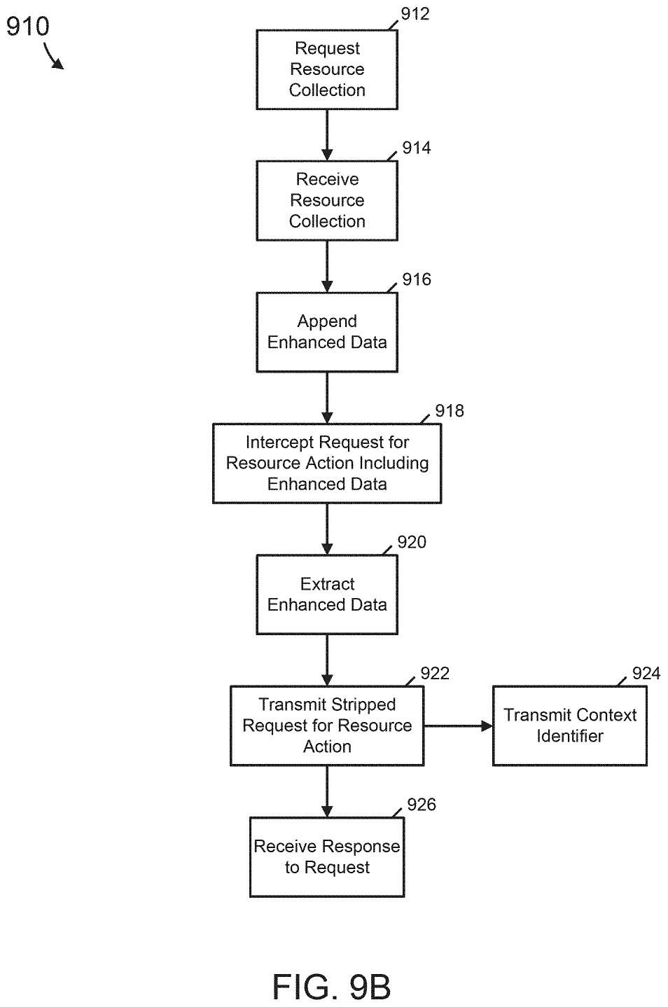

The process 810 as shown in FIG. 8B and described above does not require any changes to the client agent. Rather, as described above, all generation of metadata, enhanced metadata, and context inference is performed by the server. However, in certain examples, the client side can be modified as well to improve the inference performance of the server. FIGS. 9A and 9B illustrate a timing diagram 900 and a sample process 910 that implement appending enhanced metadata on the client-side, for example, using a software development kit (SDK) implemented by a client agent for improved inference by the server.

FIG. 9A illustrates a sample sequence diagram 900 related to process 910 as shown in FIG. 9B and described below in additional detail. The sequence diagram 900 illustrates a sample set of interactions between a client (e.g., client 406 of FIG. 4), a client SDK (e.g., client-side software implemented to a client agent such as file sharing agent 104 of FIG. 4), a server (e.g., server 404 of FIG. 4), and a context store (e.g., server 402 of FIG. 4, including file storage 106). As shown in the sequence diagram 900, the client, or a client agent running on the client, can transmit a request 901a for one or more resource collections using, for example, a resource collection API as described above. The client SDK can forward 901b the resource collection request to the server. The server can receive the request and create 902 one or more resource collections having associated resource contexts from the context store. The resource contexts can include, for example, a session identifier, a resource identifier, a creation time, a resource collection API type, and other similar metadata. The server can provide 903 the resource collections and associated resources to the client via the resource collection API. However, when transmitted to the client, the client SDK can intercept the resource collections for further processing. As shown in sequence diagram 900, the client SDK can append 904a a context identifier to the resource identifiers in the resource collection and forward 904b the resource collection information to the client, including the enhanced metadata.

Once the client has received the resource collection information, the client can request 905 a resource action using, for example, a resource action API. This request can include a resource identifier for the requested resource, the resource identified including the enhanced metadata including the context identifier. The client SDK can intercept the resource action request and extract 906a the context identifier and resource identifier from the enhanced metadata. The client SDK can the forward 906b the resource identifier to the server for further processing. The client SDK can also record the extracted context identifier to, for example, the context store as an indication of the resource context utilized by the client to request the resource action.

The server can receive the requested resource identifier from the client SDK and access the context store to retrieve the requested resource. The server can perform 907 the requested action and respond 908 to the client using the resource action API.

Referring now to FIG. 9B, process 910 can be implemented by a client-side agent that is configured to interact with a remote server to perform a similar data exchange as outlined in timing diagram 900 as shown in FIG. 9A and described above. The corresponding server-side process and interactions with the client agent can be similar to those as described above. For example, process 610 as shown in FIG. 6B and described above can be used in concert with process 910 as shown in FIG. 9B and described below to provide for improved context inference as described herein.

As shown in FIG. 9B, a processor running client-side software such as an SDK implemented by a client agent can receive a request for a resource collection from, for example, the client agent. The processor can request 912 the resource collection from the server. After a time, the processor can receive 914 the resource collection from the server. The processor can then append 916 enhanced metadata to the received resource collection. For example, as noted above, appending enhanced metadata can include adding a context identifier to an existing resource collection identifier in the resource collection. The processor can then pass the resource collection, including the enhanced metadata, to the client agent for processing as described herein.

After the client agent has processed the resource collection, the processor can intercept 918 a request for a resource action, the request including the enhanced metadata. The processor can extract 920 the enhanced metadata and determine the context identifier from the enhanced metadata. The processor can re-format the request into a format as expected by the server and transmit 922 the stripped request for resource action to the server. Similarly, the processor can also transmit 924 the context identifier to, for example, the context store as described above for later analysis. The processor can then receive 926 a response to the request for a resource action.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A computer system for inferring a context from which a resource was selected in a distributed file sharing system, the system comprising:
a memory;
a network interface; and
at least one processor coupled to the memory and the network interface and configured to
receive, from a first client agent via the network interface, a first connection request;
transmit, to the first client agent via the network interface, a response to the first connection request, the response comprising a resource collection including at least one resource;
receive, from the first client agent via the network interface, a request for the at least one resource;
generate a context inference based upon the request for the at least one resource, the context inference indicating the first client agent selected the at least one resource from the resource collection;
receive, via the network interface, a second connection request from the first client agent;
select, based on the context inference, an updated resource collection for transmission to the first client agent; and
transmit, to the first client agent via the network interface, the updated resource collection.

2. The computer system of claim 1, wherein the at least one processor is further configured to:
receive, via the network interface, a third connection request from a second client agent;
identify an association between the first client agent and the second client agent;
select, based on the association and the context inference, the resource collection for transmission to the second client agent; and
transmit, to the second client agent via the network interface, the resource collection.

3. The computer system of claim 1, wherein the at least one processor is further configured to generate, in response to reception of the first connection request, a resource context comprising a session identifier, a resource identifier, a creation timestamp, and a resource collection identifier and wherein to generate the context inference includes fetching the resource context using the session identifier, the resource identifier, and a current timestamp.

4. The computer system of claim 1, wherein the at least one processor is further configured to:
receive page hit information including a page hit timestamp from the first client agent;
generate, in response to reception of the first connection request, a resource context comprising at least a creation timestamp; and
generate the context inference based upon a comparison of the page hit timestamp and the creation timestamp.

5. The computer system of claim 1, wherein the response to the first connection request comprises metadata including a context identifier for each of a plurality of resource collections.

6. The computer system of claim 5, wherein the at least one processor is further configured to:
receive the request for the at least one resource, the request for the at least one resource comprising a portion of the metadata; and
generate the context inference based upon the at least a portion of the metadata.

7. The computer system of claim 6, wherein the at least a portion of the metadata is appended to the request for the at least one resource by the client agent in response to a user-selection of the requested at least one resource.

8. The computer system of claim 1, wherein the at least one processor is further configured to generate a response to the request for the at least one resource, the response to the request for the at least one resource comprising at least a portion of the requested at least one resource.

9. A method of inferring a context from which a resource was selected in a distributed file sharing system, the method comprising:
receiving, by a at least one processor, a first connection request from a first client agent via a network interface operably coupled to the at least one processor;
transmitting, by the at least one processor, a response to the first connection request to the first client agent via the network interface, the response comprising a resource collection including at least one resource;
receiving, by the at least one processor, a request for the at least one resource from the first client agent via the network interface;
generating, by the at least one processor, a context inference based upon the request for the at least one resource, the context inference indicating the first client agent selected the at least one resource from the resource collection;
receiving, by the at least one processor, a second connection request from the first client agent via the network interface;
selecting, by the at least one processor, an updated resource collection for transmission to the first client agent based on the context inference; and
transmitting, by the at least one processor, the updated resource collection to the first client agent via the network interface.

10. The method of claim 9, further comprising:
receiving, by the at least one processor, a third connection request from a second client agent via the network interface;
identifying, by the at least one processor, an association between the first client agent and the second client agent;
selecting, by the at least one processor, the resource collection for transmission to the second client agent based on the association and the context inference; and
transmitting, by the at least one processor, the resource collection to the second client agent via the network interface.

11. The method of claim 9, further comprising generating, by the at least one processor, a resource context in response to reception of the first connection request, the resource context comprising a session identifier, a resource identifier, a creation timestamp, and a resource collection identifier and wherein to generate the context inference includes fetching the resource context using the session identifier, the resource identifier, and a current timestamp.

12. The method of claim 9, further comprising:
receiving, by the at least one processor, page hit information including a page hit timestamp from the first client agent;
generating, by the at least one processor, a resource context comprising at least a creation timestamp in response to reception of the first connection request; and
generating, by the at least one processor, the context inference based upon a comparison of the page hit timestamp and the creation timestamp.

13. The method of claim 9, wherein the response to the first connection request comprises metadata including a context identifier for each of a plurality of resource collections.

14. The method of claim 13, further comprising:
receiving, by the at least one processor, the request for the at least one resource, the request for the at least one resource comprising a portion of the metadata; and
generating, by the at least one processor, the context inference based upon the at least a portion of the metadata.

15. A non-transitory computer readable medium storing computer executable instructions to infer a context from which a resource was selected in a distributed file sharing system, the computer executable instructions comprising instructions to:
receive a first connection request from a first client agent via a network interface;
transmit a response to the first connection request to the first client agent via the network interface, the response comprising a resource collection including at least one resource;
receive a request for the at least one resource from the first client agent via the network interface;
generate a context inference based upon the request for the at least one resource, the context inference indicating the first client agent selected the at least one resource from the resource collection;
receive a second connection request from the first client agent via the network interface;
select an updated resource collection for transmission to the first client agent based on the context inference; and
transmit the updated resource collection to the first client agent via the network interface.

16. The computer readable medium of claim 15, wherein the instructions further comprise instructions to:
receive a third connection request from a second client agent via the network interface;
identify an association between the first client agent and the second client agent;
select the resource collection for transmission to the second client agent based on the association and the context inference; and
transmit the resource collection to the second client agent via the network interface.

17. The computer readable medium of claim 15, wherein the instructions further comprise instructions to generate a resource context in response to reception of the first connection request, the resource context comprising a session identifier, a resource identifier, a creation timestamp, and a resource collection identifier and wherein to generate the context inference includes fetching the resource context using the session identifier, the resource identifier, and a current timestamp.

18. The computer readable medium of claim 15, wherein the instructions further comprise instructions to:
receive page hit information including a page hit timestamp from the first client agent;
generate a resource context comprising at least a creation timestamp in response to reception of the first connection request; and
generate the context inference based upon a comparison of the page hit timestamp and the creation timestamp.

19. The computer readable medium of claim 15, wherein the response to the first connection request comprises metadata including a context identifier for each of a plurality of resource collections.

20. The computer readable medium of claim 19, wherein the instructions further comprise instructions to:
receive the request for the at least one resource, the request for the at least one resource comprising a portion of the metadata; and
generate the context inference based upon the at least a portion of the metadata.
